(19) United States
(12) Patent Application Publication
(10) Pub. No.: US 2020/0077052 A1
(43) Pub. Date: Mar. 5, 2020

(54) INSTANT CAMERA LINK AND DISPLAY SYSTEM FOR A HANDHELD FIREARM AND METHOD OF OPERATION THEREOF

(71) Applicant: Tam Phuong Tran, San Diego, CA (US)

(72) Inventor: Tam Phuong Tran, San Diego, CA (US)

(21) Appl. No.: 16/387,814

(22) Filed: Apr. 18, 2019

Related U.S. Application Data
(60) Provisional application No. 62/726,956, filed on Sep. 4, 2018.

(51) Int. Cl. H04N 7/18; G06F 3/14; F41G 3/16

(52) U.S. Cl. CPC H04N 7/185; F41G 3/165; G06F 3/14

(57) ABSTRACT

The present invention generally relates to an instant camera link and display system for use with a handheld firearm having a video camera, a wearable display device coupled to the video camera via a video communication link, and one or more momentary activation switches coupled to the grip of the firearm, allowing a person to shoot accurately while safely hidden and without exposing his or her body.

### RELATED APPLICATIONS

This application claims the benefit of priority of U.S. Provisional Application Ser. No. 62/726,956 filed Sep. 4, 2018, which is hereby incorporated by reference in its entirety.

### FIELD OF THE INVENTION

The present invention relates to a camera mounted to a firearm for providing live-streaming view directly to a wearable viewing device worn by a user. In particular, the present invention provides an instant communication link mechanism for connecting the camera to the wearable viewing device giving the user instant viewing of a target image received by the camera on the wearable viewing device, providing an opportunity to shoot accurately without exposing his or her body.

### BACKGROUND

There are various add-on items that may be added to a handheld firearm such as a gun, pistol, paintball gun, airsoft gun or rifle to enhance its beauty and for comfort or to help the person shoot quickly and/or more accurately. For example, there are body cameras and cameras that are added to guns for accurate reporting of the event. However, when shooting, should one aim with their right eye, or with their left eye? Which eye is more dominant? Should one stand up-right and lean forward? Should one kneel so they could become a smaller target? Regardless, none of these camera products enhancements allow the person to shoot accurately while safely hidden.

Smartphones and smart devices may be connected to remote mounted cameras on the handheld weapon, providing remote viewing access of the target. However, smartphones or smart devices require authentication in order to establish a connection and to communicate between each other and external devices. The authentication process has an inherent startup delay that may take several seconds to minutes before the connection is established, making smart devices undesirable in real-time life-threatening situations like a gun battle between two or more shooters. In most scenarios, this time delay may not be a problem in situations like wirelessly pairing with a speaker or an entertainment accessory. However, in life-threatening situations, any time delays, even seconds, can make a difference between life and death.

What is needed is an improved system and method for instant connection between visual components in specific applications involving life-threatening situations and the ability to accurately shoot an opposing shooter without exposing his or her body to the opposing shooter.

### SUMMARY

It is an advantage of the present invention to provide an instant camera link and display system for use with a handheld firearm having a grip having a video camera coupled to a top portion of the firearm, the video camera is configured to receive a live video feed of a target in a line of sight of the firearm; a wearable display device coupled to the video camera via a video communication link, the wearable display device is configured to display the live video feed of the target on a portable display instantly and without any startup delay when activated, the wearable display device is worn by a user; and one or more momentary activation switches coupled to the grip of the firearm, the instant camera link and display system is activated when the grip of the firearm is grasped by the user causing the one or more momentary activation switches in a closed switch position and deactivated when the grip of the firearm is released by the user causing the one or more momentary activation switches in an open switch position.

It is another advantage of the present invention to provide an instant camera link and display system for use with a handheld firearm having a grip having a video camera coupled to a top portion of the firearm, the video camera is configured to receive a live video feed of a target in a line of sight of the firearm; a wearable display device coupled to the video camera via a video communication link, the wearable display device is configured to display the live video feed of the target on a portable display instantly and without any startup delay when activated, the wearable display device is worn by a user; and a single power switch coupled to either the video camera or the wearable display device, the single switch is configured to activate and deactivate the video camera and the wearable display device simultaneously.

In one aspect, the video communication link is a wired connection. In another aspect, the video communication link is a wireless connection. In yet another aspect, the wearable display device includes a wrist wearable display device.

In one implementation, the wrist wearable display device includes the portable display and a wristband. In another implementation, the portable display is configured to tilt and pivot along a tilting member coupled to a support base on which the portable display rests. In yet another implementation, the portable display is configured to rotate and swivel along a rotating member that is coupled to the tilting member and the support base.

These and other objects, features and advantages of the present invention will become more apparent in light of the following detailed description of preferred embodiments thereof, as illustrated in the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 illustrates an instant camera link and display system for a handheld firearm according to an embodiment.

FIG. 2 illustrates a wireless instant camera link and display system according to another embodiment.

FIG. 3 illustrates various components and features of the wearable display device according to another embodiment.

FIG. 4A-FIG. 4D illustrates the wearable display device having a rotating and tilting member according to another embodiment.

FIG. 5A-FIG. 5B illustrate an eye wearable display device used in the instant camera link and display system, according to another embodiment.

FIG. 6A-FIG. 6B illustrate target markers of the portable display according to another embodiment.

FIG. 7A-FIG. 7C illustrate a front, side, and perspective view, respectively, the video camera, according to another embodiment.

FIG. 8 illustrates the instant camera link and display system having an external battery source to power the instant camera link and display system, according to another embodiment.

FIG. 9 illustrates a flowchart demonstrating steps for applying, activating and acquiring video images on the instant camera link and display system, according to another embodiment.

FIG. 10 illustrates a single power switch configuration of the wireless instant camera link and display system, according to another embodiment.

FIG. 11 illustrates the user grasping the firearm with the instant camera link and display system attached to the firearm and wrist of the user, according to another embodiment.

### DETAILED DESCRIPTION

In a gun fight, it is highly undesirable to expose any parts of your head, limbs or body in case someone is waiting to shoot at you. However, until you are able to survey your surroundings, there is no convenient way to know what is coming. If you are in a situation where you cannot retreat, and must stay in the fight, every shot must hit its target as quickly and accurately as possible in order to survive the attack from an opposing shooter. Thus, it is critical to be able to shoot accurately but stay hidden from direct contact or line-of-sight with the opposing shooter in the gun fight. To shoot accurately one must aim the gun by looking directly at the rear sight, front sight, and the opposing shooter (target) simultaneously. Meaning that, in order to shoot accurately, your head and a portion of your body must be exposed in order to accurately aim at the target. Exposing your head to a threat is never a good idea in the gun fight for the obvious reason of the possibility of getting shot by the opposing shooter. Thus, one objective this invention is to provide a system that allows a person to safely and accurately shoot at the opposing shooter while keeping most of their body and head safely hidden from the opposing shooter while another objection of this invention is the system having an instant camera link and display system for use with a handheld firearm displaying a live video feed of the target on a portable display instantly and without any startup delay when activated.

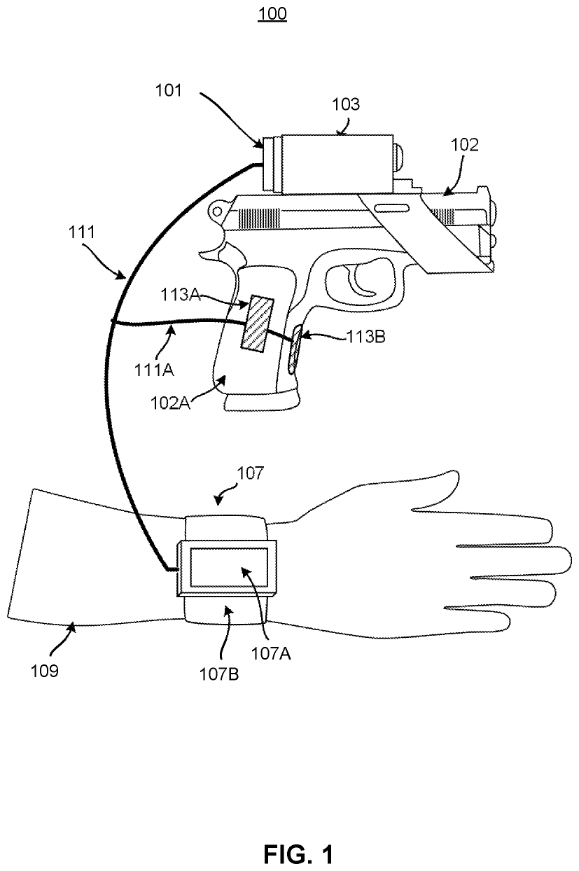

FIG. 1 illustrates an instant camera link and display system 100 for a handheld firearm 102 according to an embodiment. The instant camera link and display system 100 may include, for example, a video camera 101 coupled to a scope (or sight) 103, where the video camera 101 and the scope 103 may include attachment members and fasteners that attach to a rail of the firearm 102 between the rear sight and the front site of the firearm 102. In some implementations, the scope 103 may have zooming and night-vision capabilities, providing enhanced viewing, display, and targeting capabilities to a user 109. The system 100 may also include a wearable display device 107 having a portable display 107A worn on the wrist of the user 109 and secured to the wrist via a wrist strap or wristband 107B. In one embodiment, the video camera 101 may include a video output port (not shown) which is coupled to a video input port (not shown) of the wearable display device 107 via a wired connection 111 for transmitting a video signal of images received and captured by the video camera 101 to the wearable display device 107. In one aspect, the video camera 101 may be either analog or digital camera. The video signal may include analog or digital video, including composite video signals, s-video signals, component video signals, VGA signal, DVI signals, and HDMI signals. The wired connection 111 may include, for example, composite video cables, RCA cables, S-Video cables, DVI cables, and HDMI cables. Because the video camera 101 and the wearable display device 107 is connected through a direct and physical connection, there is no startup delay and real-time video images from the video camera 101 is instantaneously and simultaneously received by the wearable display device 107 the moment the system 100 is powered on by the user 109. In this embodiment, both the wearable display device 107 and video camera 101 may have its own power source (e.g., internal rechargeable battery). Also in this embodiment, the system 100 may include one or more momentary activation switches (113A, 113B), applied to a portion of the grip 102A of the firearm 102 and coupled to the wired connection 111 via a secondary wired connection 111A. The one or more momentary activation switches (113A, 113B) may be encased in a rectangular, oval, or bean shaped pad having an adhesive backing, providing the user 109 comfort when grasping the grip of the firearm 102. The system 100 may also include a power control circuit (not shown) that manages and controls power between the wearable display device 107, the video camera 101 and the remote activation switch. In operation, when the user 109 firmly grasps the grip 102A of the firearm 102, contact is made to the one or more of the momentary activation switches (113A, 113B), causing the video camera 101 and the wearable display device 107 to instantaneously and simultaneously power up having no startup delay. Upon release (that is, when the user 109 is no longer grasping the grip 102A of the firearm 102), power is immediately disabled to the system 100, causing the system 100 to conserve and prolong battery life to both the video camera 101 and display device 107. The momentary activation switch may include, for example, a momentary push button switch, a capacitive touch proximity sensing switch, or other types of momentary switching circuits or discrete devices.

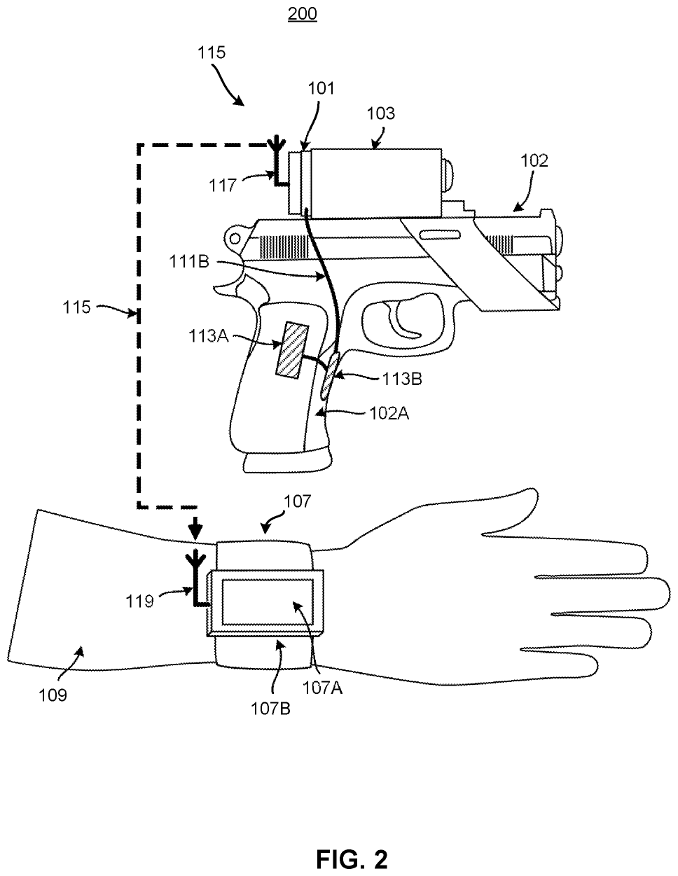

FIG. 2 illustrates a wireless instant camera link and display system 200 according to another embodiment. In this embodiment, the wireless instant camera link and display system 200 may include the video camera 101, the scope 103, the wearable display device 107, and the momentary activation switches (113A, 113B), each operating in a similar fashion as described in the previous embodiment in system 100. However, in the wireless instant camera link and display system 200, the video camera 101 includes a wireless transmitter and antenna 117 for transmitting a wireless video signal 115 of real-time video images received and captured by the video camera 101 to an antenna and wireless video receiver 119 built into the wearable display device 107.

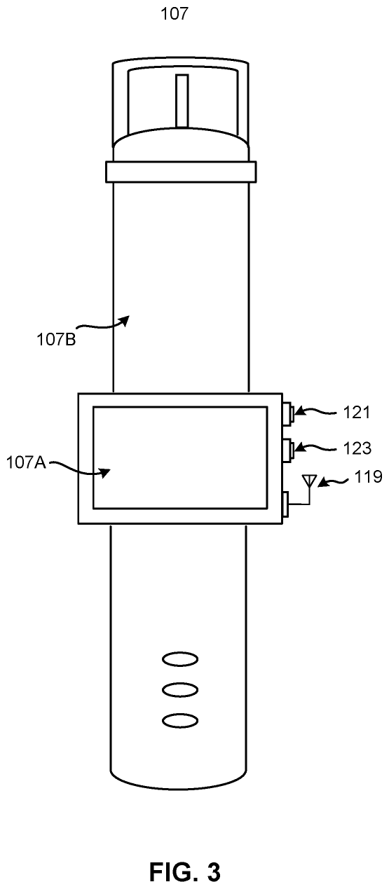

FIG. 3 illustrates various components and features of the wearable display device 107 according to another embodiment. In practice, the wearable display device 107 is generally similar to a watch-like device that is small, lightweight and compact enough to be comfortably worn on the wrist of the user 109, including the portable display 107A and the wristband 107B. For example, the portable display 107A may include a 2″-4″ (diagonal) mini LED, LCD, or TFT display panel driven and controlled by a display controller and powered by an internal rechargeable battery. The portable display 107A may also include power input connector 121 for receiving an external power source and a video connector input port 123 for receiving a video cable connector attached to the wired connection 111. Examples of some video connectors include BNC connectors, DisplayPort Connectors, DVI-D connectors, HDMI connectors, RCA connectors, S-Video connectors, and VGA connectors. The wearable display device 107 may also include circuit components 107F such as a display controller, microprocessor, logic components, volatile memory, wireless communication circuitry, an antenna, a non-volatile storage (flash memory), and an internal rechargeable battery. In another implementation, the wearable display device 107 may be configured to process, record and store the video images received by the video camera onto a separate flash memory card. The wristband 107B may include highly durable yet comfortable materials such as leather, silicone, nylon, and rubber.

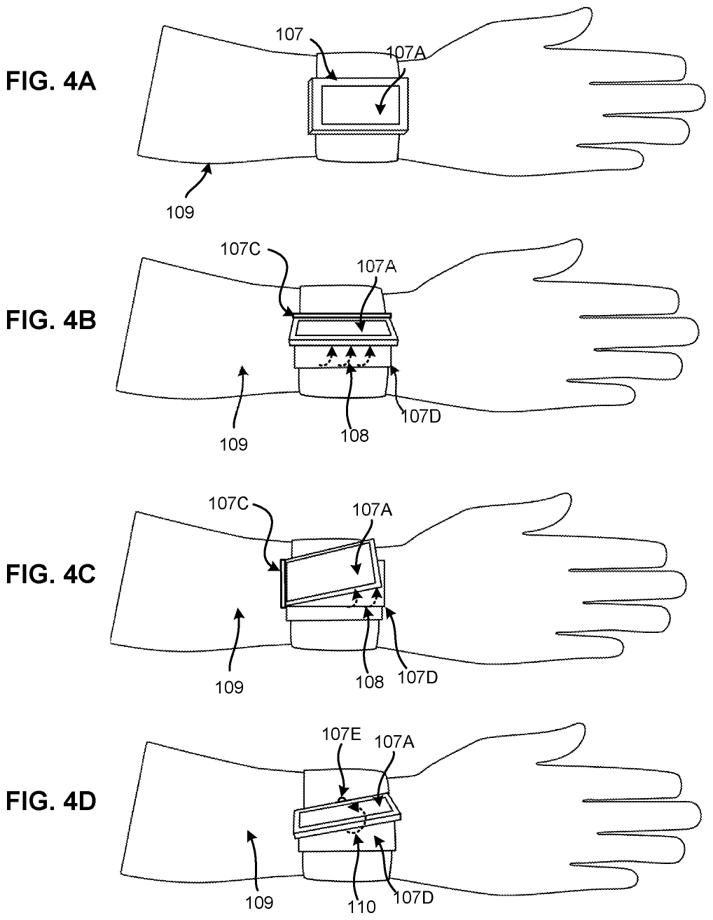

FIG. 4A-FIG. 4D illustrates the wearable display device 107 having a rotating and tilting member according to another embodiment. In FIG. 4A, the wearable display device 107 is worn and secured on the wrist of the user 109 with the portable display 107A at a first position being flushed to the wrist. In FIG. 4B and FIG. 4C, the portable display 107A may be configured to tilt and pivot (arrows 108) along a tilting member 107C coupled to an optional support base 107D on which the portable display 107A may rest when in a flushed position to the wrist of the user 109. For example, the tilting member 107C may include a hinge, a flush hinge, or spring hinge, allowing the user 109 to mechanically lift and adjust the portable display 107A at various viewing angles relative to the wrist. In addition to the tilting member 107C, the portable display 107A may be configured to rotate and swivel (arrows 110) along a rotating member 107E that is coupled to the tilting member 107C and the optional support base 107D as shown in FIG. 4D. The rotating member 107E, for example, may include a rotating joint or swivel joint, allowing the user 109 to fine tune and adjust the portable display 107A at various viewing angles and positions relative to the wrist. In practice, the user 109 may have to rotate or bend their arm when shooting around corners causing the portable display 107A of the wearable display device 107 to be difficult to view when attached and flushed to the wrist. Thus, the tilting and rotating members (107C, 107E) allows the user 109 to dynamically adjust the portable display 107A at an optimal viewing angle and position so that the user 109 is capable of fully viewing the portable display 107A when the arm is bent or rotated.

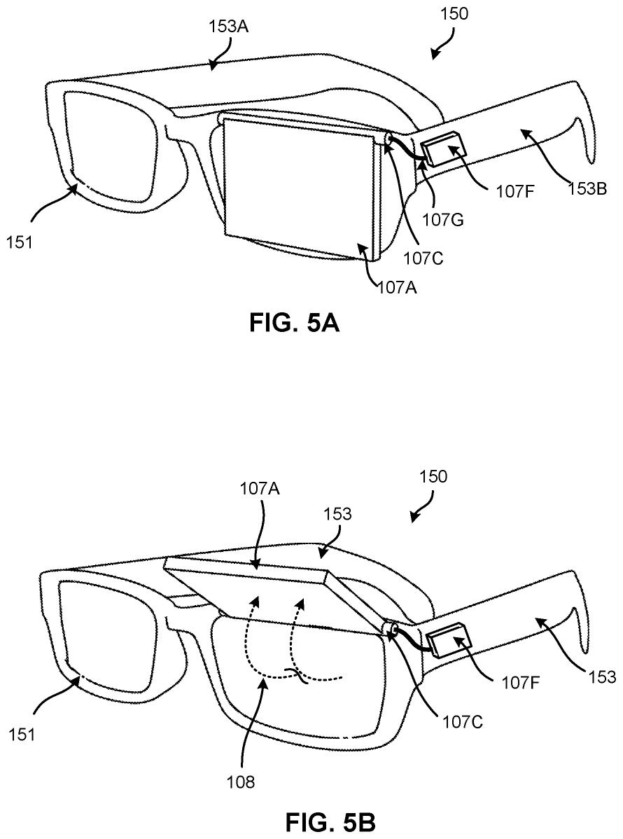

FIG. 5A-FIG. 5B illustrate an eye wearable display device 150 used in the instant camera link and display system (100 or 200) according to another embodiment. The eye wearable display device 150 may include a pair of eye glasses having an eyeglass front frame 151, left and right temples (153A, 153B), and the portable display 107A coupled to the eyeglass front frame 151 via the mechanical tilting member 107C. The eye wearable display device 150 may also include circuit components 107F such as a display controller, microprocessor, logic components, volatile memory, wireless communication circuitry, an antenna, a non-volatile storage (flash memory), and an internal rechargeable battery. The portable display 107A may be coupled to the circuit components 107F via wired connector 107G and wirelessly coupled to the video camera 101 as previously described hereinabove. In one embodiment, the portable display 107A may be configured to tilt (arrows 108) along the tilting member 107C that is coupled along a top portion of the eyeglass front frame 151 as shown in FIG. 5B. The tilting member 107C allows the user 109 to flip up the portable display 107A out of direct viewing, allowing the user 109 an unobstructed view while wearing the eyeglass front frame 151. In another embodiment, the portable display 107A may be shaped as a lens and integrated into the eyeglass frame 151. In practice, the eye wearable display device 150 may provide the user 109 an alternative and convenient method of viewing camera video images from the video camera 101 directly.

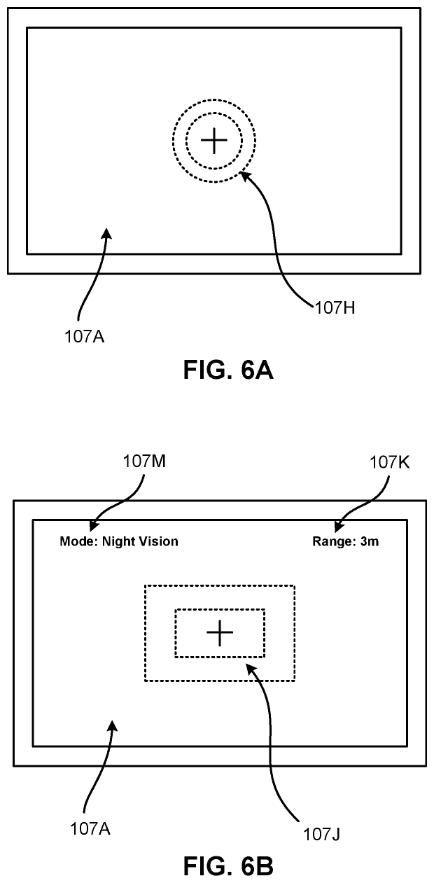

FIG. 6A-FIG. 6B illustrate target markers (107H, 107J) of the portable display 107A according to another embodiment. Target markers (107H, 107J) provided target shooting references to accurately aim and shoot at the target and may be physically embedded or digitally generated and displayed on the portable display 107A. Target markers may include various marker shapes such as a circular marker (107H) or rectangular marker (107J). In addition to target markers, the portable display 107A may include target acquisition information 107K, mode and calibration setting information 107M, and other visual information to assist the user 109 with target accuracy.

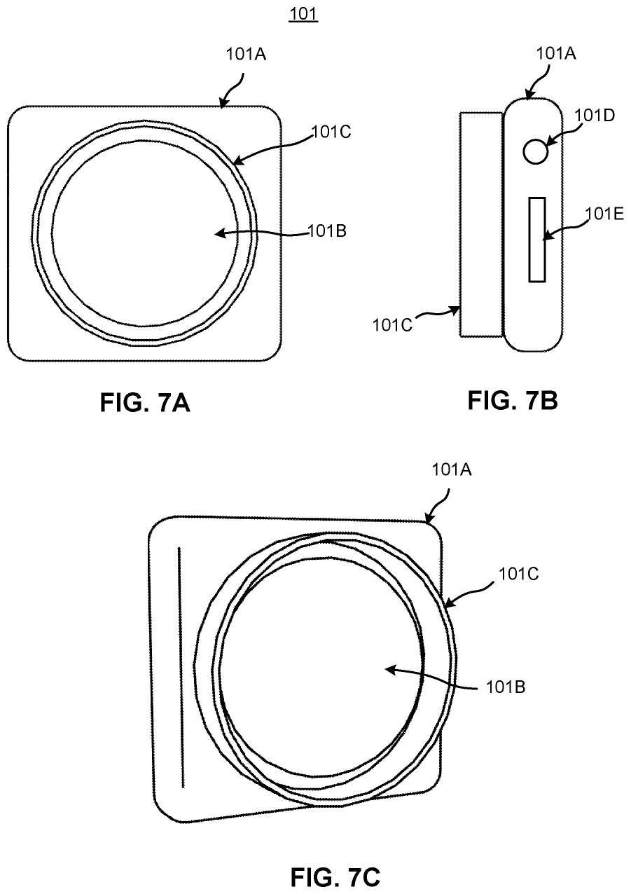

FIG. 7A-FIG. 7C illustrate a front, side, and perspective view, respectively, the video camera 101 according to another embodiment. The video camera 101 is an electronics image capturing device having a housing 101A, a lens 101B, and an optional mounting bracket 101C coupled to the housing 101A. The video camera 101 may be a high definition camera and the lens 1013 may include a high resolution lens assembly for capturing high resolution video images. The mounting bracket 101C may be configured to mount on the optional scope 103 using a mounting ring when attached. In another implementation, the video camera 101 is configured to be detachably coupled to the firearm 102 so that the instant camera link and display system (100 or 200) may receive and be replaced by a variety of different video cameras. In practice, the video camera may be attached preferably, but not necessary, behind the gun sights without the scope or behind the scope of the firearm if the scope is attached. The video camera 101 may include multiple video input ports (101D, 101E) for receiving different types of video input connectors. In other applications, the video camera 101 may also include internal wireless circuit components such as a microprocessor, logic components, volatile memory, wireless communication circuitry, an antenna, a non-volatile storage (flash memory), and an internal rechargeable battery.

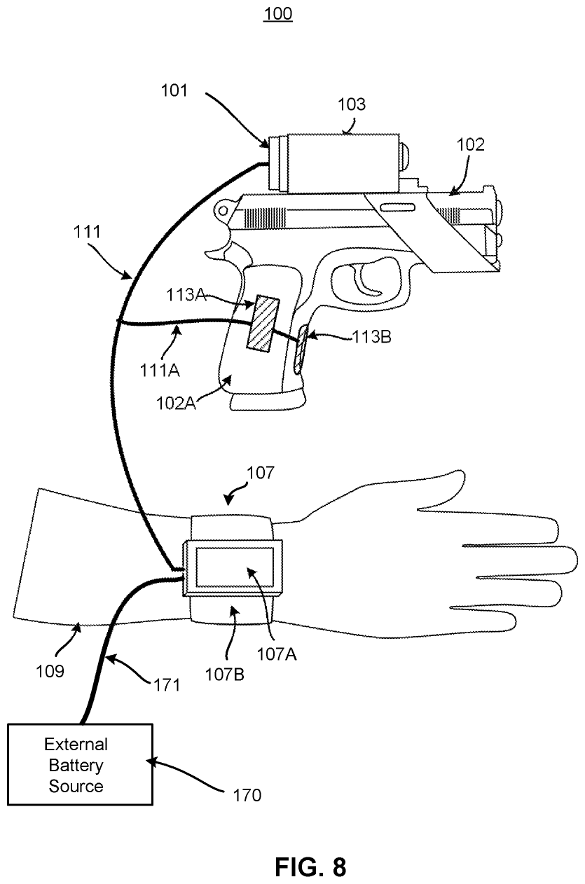

FIG. 8 illustrates the instant camera link and display system 100 having an external battery source 170 to power the instant camera link and display system (100 or 200) according to another embodiment. The external battery source 170 may be directly connected to the power input connector 121 of the portable display 107A via a wired connection 171. Examples of external battery sources include primary cells (non-rechargeable batteries) and secondary cells (rechargeable batteries), including but not limited to alkaline batteries, lithium batteries, LiON batteries, and NiCAD batteries.

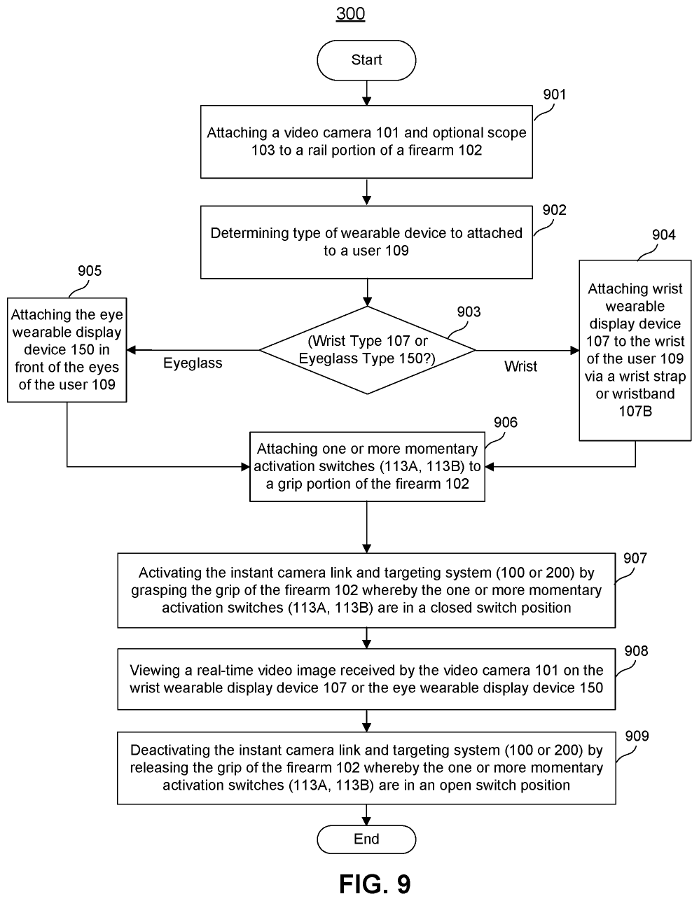

FIG. 9 illustrates a flowchart 300 demonstrating operational steps of the instant camera link and display system (100 or 200) according to another embodiment. These operational steps include:
1) Attaching a video camera 101 and optional scope 103 to a rail portion of a firearm 102 (Step 901);
2) Determining type of wearable device to attached to a user 109 (Step 902);
3) Wrist Type 107 or Eyeglass Type 150? (Step 903);
4) Attaching wrist wearable display device 107 to the wrist of the user 109 via a wrist strap or wristband 107B (Step 904);
5) Attaching the eye wearable display device 150 in front of the eyes of the user 109 (Step 905);
6) Attaching one or more momentary activation switches (113A, 113B) to a grip portion of the firearm 102 (Step 906);
7) Activating the instant camera link and display system (100 or 200) by grasping the grip of the firearm 102 whereby the one or more momentary activation switches (113A, 113B) are in a closed switch position (Step 907);
8) Viewing a real-time video image received by the video camera 101 on the wrist wearable display device 107 or the eye wearable display device 150 (Step 908);
9) Deactivating the instant camera link and display system (100 or 200) by releasing the grip of the firearm 102 whereby the one or more momentary activation switches (113A, 113B) are in an open switch position (Step 909).

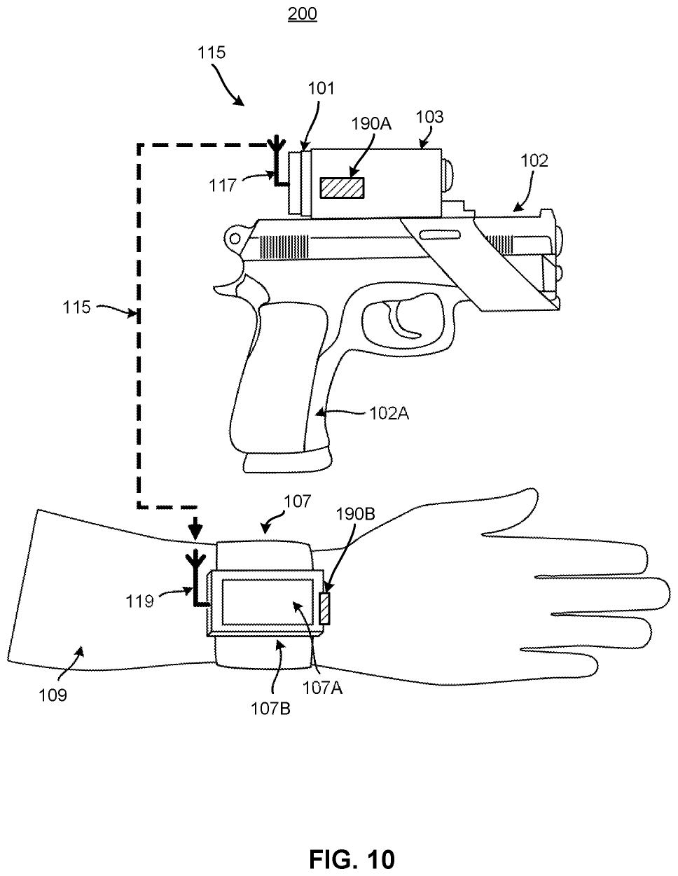

FIG. 10 illustrates a single power switch configuration of the wireless instant camera link and display system 200 according to another embodiment. In this embodiment, the momentary activation switches in the previous examples may be replaced with a single power switch (190A or 190B) that is coupled to either the video camera 101 (see power switch 190A) or the wearable display device 107 (see power switch 190B) where the single switch (190A or 190B) is configured to activate and deactivate the video camera 101 and the wearable display device 107 simultaneously.

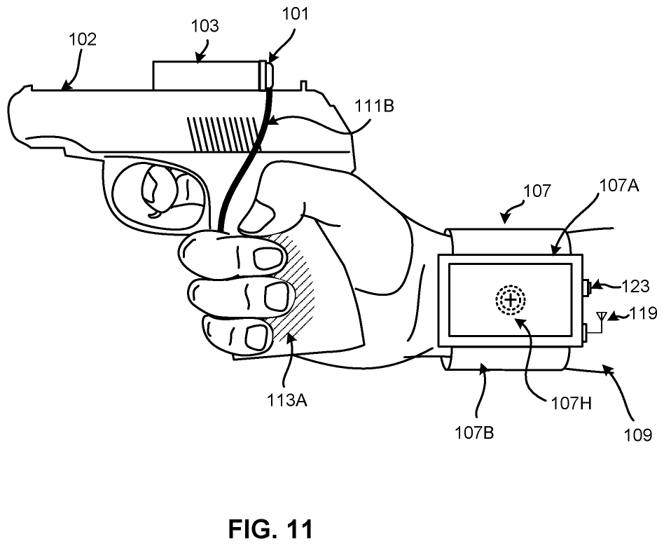

FIG. 11 illustrates the user 109 grasping the firearm 102 with the instant camera link and display system 100 attached to the firearm 102 and wrist of the user 109, according to another embodiment. Advantages of the instant camera link and display system (100 or 200) include a quick and instantaneous communication and video transmission link between the video camera 102 and the wearable display device (107 or 150). Upon power up, the instant camera link and display system (100 or 200) is capable of capturing the live video image of the target received by the video camera 101 and displaying the live video image of the target onto the wearable display device (107 or 150). In addition, by having the live video images of the target transmitted directly onto the wrist or to the eye of the user 109, the instant camera link and display system (100 or 200) allows the user 109 the ability to aim the firearm 102 by using and viewing the wearable display device (107 or 150) instead of looking directly at the rear sight, front sight, and the opposing shooter, keeping the body and head of the user 109 safely hidden from the opposing shooter. In practice, the instant camera link and display system (100 or 200) makes it possible to accurately aim and shoot while hidden at a corner of a wall or blocked by a barrier. Because of the direct and wired or wireless video connection between the video camera 101 and the wearable display device (107 or 150), the instant camera link and display system (100 or 200) can immediately display the live video image of the target upon power-up without the need of authentication or other software applications that may interfere with displaying the live video image to the wearable display device (107 or 150). In another implementation, because the video camera 101 is detachable, it may be placed on any part of the firearm. Also, the video camera 101 may be easily removed and stored away while not in use and connected the firearm when needed. In yet another implementation, the video camera 101 can be used with or without the scope 103.

As used in the specification and the appended claims, the singular forms “a”, “an”, and “the” included plural referents unless the context clearly dictates otherwise.

All patents, patent applications, and other references cited herein are incorporated by reference in their entireties.

It is noted that the foregoing disclosure has been provided merely for the purpose of explanation and is in no way to be construed as limiting of the present invention. Although the present invention has been shown and described with respect to several preferred embodiments thereof, various changes, omissions, and additions to the form and detail thereof, may be made therein, without departing from the spirit and scope of the invention. It is understood that the words which have been used herein are words of description and illustration, rather than words of limitation. Changes may be made, within the purview of the appended claims, as presently stated and as amended, without departing from the scope and spirit of the present invention in its aspects.

Other embodiments and modifications of the present invention may occur to those of ordinary skill in the art in view of these teachings. Accordingly, the invention is to be limited only by the following claims which include all other such embodiments and modifications when viewed in conjunction with the above specifications and accompanying drawings.

What is claimed is:

1. An instant camera link and display system for use with a handheld firearm having a grip comprising:
a video camera coupled to a top portion of the firearm, wherein the video camera is configured to receive a live video feed of a target in a line of sight of the firearm;
a wearable display device coupled to the video camera via a video communication link, wherein the wearable display device is configured to display the live video feed of the target on a portable display instantly and without any startup delay when activated, wherein the wearable display device is worn by a user; and
one or more momentary activation switches coupled to the grip of the firearm, wherein the instant camera link and display system is activated when the grip of the firearm is grasped by the user causing the one or more momentary activation switches to be in a closed switch position and deactivated when the grip of the firearm is released by the user causing the one or more momentary activation switches to be in an open switch position.

2. The instant camera link and display system of claim 1, wherein the video communication link is a wired connection.

3. The instant camera link and display system of claim 1, wherein the video communication link is a wireless connection.

4. The instant camera link and display system of claim 1, wherein the wearable display device includes a wrist wearable display device.

5. The instant camera link and display system of claim 4, wherein the wrist wearable display device includes the portable display and a wristband.

6. The instant camera link and display system of claim 5, wherein the portable display is configured to tilt and pivot along a tilting member coupled to a support base on which the portable display rests.

7. The instant camera link and display system of claim 6, wherein the portable display is configured to rotate and swivel along a rotating member that is coupled to the tilting member and the support base.

8. The instant camera link and display system of claim 4, wherein the wrist wearable display device includes a power input connector for receiving an external power source and a video connector input port for receiving a video signal.

9. The instant camera link and display system of claim 4, wherein the wrist wearable display device includes a display controller, a microprocessor, logic components, volatile memory, wireless communication circuitry, an antenna, a non-volatile storage and an internal rechargeable battery.

10. The instant camera link and display system of claim 9, wherein the video connector input includes BNC connectors, DisplayPort Connectors, DVI-D connectors, HDMI connectors, RCA connectors, S-Video connectors, or VGA connectors.

11. The instant camera link and display system of claim 1, wherein the portable display includes target markers having target shooting references to accurately aim and shoot at a target, wherein the target markers are physically embedded or digitally generated and displayed on the portable display.

12. The instant camera link and display system of claim 1, wherein the portable display includes target acquisition information, mode and calibration setting information, and other visual information to assist the user with target accuracy.

13. The instant camera link and display system of claim 10, wherein eye wearable display device includes a pair of eye glasses having an eyeglass front frame, left and right temples, and the portable display coupled to the eyeglass front frame via a mechanical tilting member.

14. The instant camera link and display system of claim 12, wherein the eye wearable display device includes circuit components including a display controller, a microprocessor, logic components, volatile memory, wireless communication circuitry, an antenna, a non-volatile storage and an internal rechargeable battery.

15. The instant camera link and display system of claim 1, wherein the video camera includes a housing, a lens, and an mounting bracket coupled to the housing of the video camera.

16. The instant camera link and display system of claim 1, wherein the video camera is configured to be detachably coupled to the firearm.

17. The instant camera link and display system of claim 1, wherein the video camera includes multiple video input ports for receiving different types of video input connectors.

18. The instant camera link and display system of claim 1 further comprising an external battery source to power the instant camera link and display system.

19. The instant camera link and display system of claim 1 further comprising a scope coupled to the video camera and the top portion of the firearm.

20. An instant camera link and display system for use with a handheld firearm having a grip comprising:
a video camera coupled to a top portion of the firearm, wherein the video camera is configured to receive a live video feed of a target in a line of sight of the firearm;
a wearable display device coupled to the video camera via a video communication link, wherein the wearable display device is configured to display the live video feed of the target on a portable display instantly and without any startup delay when activated, wherein the wearable display device is worn by a user; and
a single power switch coupled to either the video camera or the wearable display device wherein the single switch is configured to activate and deactivate the video camera and the wearable display device simultaneously.
